(19) United States
(12) Patent Application Publication
(10) Pub. No.: US 2015/0260455 A1
(43) Pub. Date: Sep. 17, 2015

(54) METHOD FOR FILTERING AN AIR FLOW IN A GRAIN DRYER

(71) Applicant: CERES, La Chapelle Lasson (FR)

(72) Inventor: M. Laurent LALLOUET, Equemauville (FR)

(73) Assignee: CERES, La Chapelle Lasson (FR)

(21) Appl. No.: 14/207,271

(22) Filed: Mar. 12, 2014

(51) Int. Cl. F26B 21/00; F26B 17/12

(52) U.S. Cl. CPC F26B 21/003; F26B 17/12

(57) ABSTRACT

The method for filtering an air flow in a grain dryer to permit recycling of the air includes entering an external air flow into the grain dryer; pouring a grain flow by gravity into the grain dryer; passing the external air flow through the grain flow in a direction substantially perpendicular to the direction of the grain flow; filtering the air flow after passing through the grain flow so as to retain particles present in the air flow; heating the filtered flow and directing the filtered flow upstream of the grain flow, such that the filtered flow passes again through the grain flow; and blowing the particles proceeding from the filtering. The invention also relates to a device for implementing this method.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention is related to the field of agricultural machine equipment mainly for the agricultural or agro-food industries.

The present invention is particularly intended to be applied in grain dryers.

The invention relates in particular to a method and a device for filtering air permitting recycling of the air stream flowing in a grain dryer.

2. Description of Related Art Including Information Disclosed Under 37 CFR 1.97 and 37 CFR 1.98

A grain dryer allows, after their harvest, their drying. Indeed, when said grains are harvested from the base of the plant, they have not had enough time to dry sufficiently. The presence of residual moisture inside the grains can be problematic at the time of storage of said grains, namely since it promotes fermentation and oxidation of the latter. Therefore, the use of a grain dryer, after the harvest, is essential in order to be able to store the grain under optimal conditions and to avoid any degradation of the latter.

Traditionally, a grain dryer for this type of application is comprised of at least one column, in which the grains can flow, namely by gravity. The grains are deposited in bulk at the level of the upper portion of the column and leave dry at the lower portion.

Along their path inside the drying column or columns, the grains are into contact with air having a more or less high temperature, the air circulating in the drying columns being recycled traditionally.

The recycling of the air in the traditional grain dryers is generally allowed by installing at least one filter, for example “bag filters”, often used in industrial environments.

More particularly, the bag filters, which can be arranged either horizontally or vertically, permit a separation of the dust transported by an air stream and collected in a conduit.

Patents RU 2191061, JP 2000001224 and JP 11124232 namely describe the use of bag filters in order to trap the dust when recycling the air flowing in a grain dryer.

The bag filters have the advantage of permitting an efficient dust separation; however, said filters the grain dryers are provided with must periodically be submitted to dust-removal operations.

Therefore, a grain dryer including a bag filter must be shut down on average once every week, this namely in order to clean these filters that become clogged by the dust. This tedious and labor-intensive operation is however necessary; indeed, the presence of a clogged bag filter can, on the one hand, significantly reduce the performances of the grain dryer and, on the other hand, lead to an increase in energy consumption of the dryer.

As regards in particular the patent JP 2000 001224, it provides a device into which grains or powders are poured, through a conduit, from a container. At the level of the conduit is positioned an envelope, which is provided with an air-replacement orifice. At the level of this orifice is positioned a filter, the outer portion of which is covered with a cap connected to a dust collector. A clearance is provided between said cap and the filter, so as to permit an inlet of air proceeding from outside the device.

However, this device has a number of drawbacks, and in particular it does not allow an active drying, through an air flow, of the product circulating through the conduit, and therefore, a recirculation and recycling of the air flow is not provided for.

In addition, the disadvantages of the above-mentioned bag filters are also found in this device.

Other types of filters are described in the state of the art, for example in U.S. Pat. No. 4,563,200 and U.S. Pat. No. 4,690,700. However, these filters are in no way suitable for grain dryers.

### SUMMARY OF THE INVENTION

The invention provides the possibility of coping with the various drawbacks of the state of the art by providing a method and a device for filtering the air flowing in a dryer, without requiring a weekly shutdown of the grain dryer in order to proceed to a dust-removal of the filter.

To this end, the present invention relates to a method for filtering an air flow in a grain dryer permitting to recycle the air, wherein:
an external air flow is allowed to enter into said grain dryer;
a grain flow is poured by gravity into said grain dryer;
said air flow of is caused to pass through the grain flow in a direction substantially perpendicular to the direction of the grain flow;
the air flow is filtered once it has passed through the grains, so as to retain the particles present in the air flow;
the filtered flow is heated and is directed upstream of the grain flow, such that said filtered flow passes again through the grains; and
the particles proceeding from the filtering are blown.

Preferably, the air flow is filtered a second time, after it has passed again through the grain flow, the particles proceeding from the second filtering then being blown.

The present invention also relates to a device for implementing the method according to the invention consisting of a grain dryer including a vertical drying column, permitting the passage of a grain flow for drying and cooling the latter by circulation of an air flow substantially perpendicular to the direction of the grain flow, said device being characterized in that it includes at least one filtering means permitting to filter the air flow leaving said column and to retain the particles present in said air flow, said device also including at least one movable air blowing means associated with the filtering means, permitting to blow particles proceeding from the filtering, said blowing means being supplied with air by at least one air-supply means.

Advantageously, the filtering means consists of at least one flat filter, the latter comprising at least one filtering level, and extending over at least part of the height of said vertical drying column of the grain dryer.

Preferably, said flat filter includes two filtering levels, each of the filtering levels consisting of a filtering plate.

Advantageously, said flat filter is contained in a plane.

According to another embodiment, said flat filter includes two facets, each of these facets being contained in two different planes.

Interestingly, the means for supplying air to the blowing means consists of a fan arranged in the lower portion of the grain dryer, and/or of a carried-on fan associated with the blowing means.

According to another peculiarity of the invention, the mobile blowing means consists of a blowing nozzle, the latter being arranged on the side of the filtering means opposite the one where the drying column is located, said blowing nozzle having substantially the same width as said filtering means and including at least air-capturing means.

Advantageously, the device also includes conveying means permitting a displacement of the blowing means along said filtering means.

The present invention includes many advantages. On the one hand, the method and the device according to the invention permits drying the grains. In addition, a recycling of all the air flowing in the lower portion of the dryer is performed; indeed, the air flow entering into the grain dryer and passing through the grain flow is afterwards fully filtered before entering into the upper portion of said dryer where said air flow is heated and then passes again through the grain flow. It is then not necessary to cause an external air flow to be heated and to be mixed with a partially recycled internal air to enter again; this permits namely to avoid the risk of fire within the dryer. The air passing through the grains in the upper portion of the dryer is also preferably recycled.

On the other hand, the method and the device according to the invention permit to avoid the filtering means, preferably consisting of a flat filter, from clogging because of the presence of dust; indeed, the step of blowing namely by means of at least one blowing nozzle causes an automatic and continuous efficient cleaning of the whole of the filtering means.

Therefore, the user of the present device is no longer obliged to frequently maintain the filtering means of the grain dryer if he does not want the energy consumption of its dryer to increase. The invention therefore has an undeniable economic advantage and permits to save time on maintenance of the grain dryers.

Other features and advantages of the invention will become clear from the following detailed description of the non-restrictive embodiments of the invention, with reference to the attached figures.

### BRIEF DESCRIPTION OF THE DRAWINGS

FIG. 1 schematically shows a cross-sectional view of a particular embodiment of the device according to the invention, in which a grain dryer includes a filtering means that consists of a flat filter.

FIG. 2 schematically shows a three-quarter perspective view of the top of the blowing nozzle permitting to remove the dust from the flat filter arranged in a grain dryer.

### DETAILED DESCRIPTION OF THE DRAWINGS

The present invention relates to a method for filtering an air flow in a grain dryer 1, said method according to the invention permitting advantageously an optimal recycling all of the whole air flow used in said grain dryer 1.

The method according to the present invention permits in addition a grain drying with said air flow.

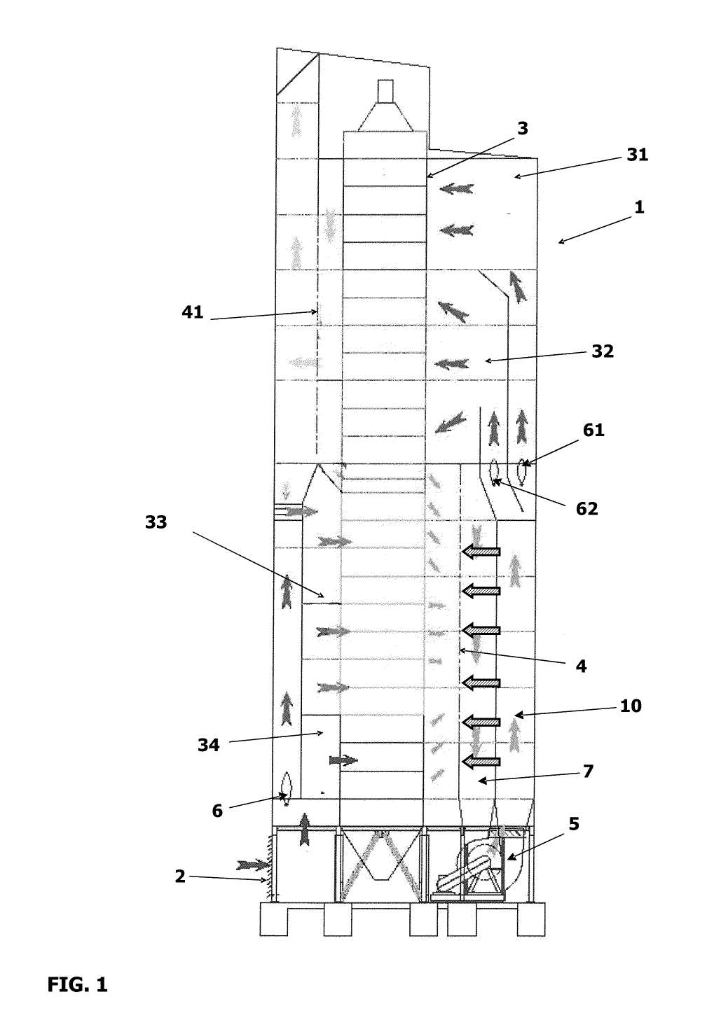

The air flow flowing in the grain dryer 1 is symbolized, in the attached FIG. 1, by the solid arrows.

In a first process step, an external air flow is caused to enter into the grain dryer 1. The entering of the air flow can for example occur through an inlet port 2, the latter being preferably situated in the bottom, or lower, portion of said grain dryer 1.

A grain flow is then poured by gravity into the grain dryer.

Advantageously, this grain flow is poured inside a vertical drying column 3 located in said dryer 1. In this column 3 grains are caused to transit through a plurality of drying and cooling areas 31 to 34 so as to permit an optimal drying thereof.

Through the grain flow poured into said dryer 1, the air flow is caused to pass in a direction substantially perpendicular to the direction of the grain flow.

In particular, the external air flow, which has been entered into the grain dryer 1 passes in a first step through the grain flow at the level of a lower drying area 33 and a cooling area 34 of the drying column 3.

Preferably, said external air flow can be heated before it passes through the grain flow, namely in the lower drying area 33. Such an operation can namely be performed by means of heating means 6 visible in the attached FIG. 1.

After having passed through the grains, in order to dry them, the air flow is filtered. This operation advantageously permits to retain the particles or dust collected by the air flow as it passes through the grain flow.

Thus, following the filtering step, an air flow completely free of the impurities having a diameter greater than the mesh size of the filtering means used is obtained, and said air flow will then be able to be re-used. The filtered air flow is then preferably reheated, then directed upstream of the grain flow. The air flow is then caused to pass again, after filtering, through the grain flow.

In other words, the air flow passes in a first step through the grain flow in the lower portion of the grain dryer 1, at the level of the lower areas designated by 33 and 34, eventually after having been heated. After air flow has been filtered the at the exit of the grain flow, the air is preferably heated again and directed to the upper portion of said dryer 1 where it will pass again through the grain flow, at the level of the upper drying areas 31 and 32, located upstream of the areas 33 and 34, with respect to the grain flow.

In order to complete the process according to the invention, and according to an essential step of this process, the particles proceeding from the filtering are blown, so as to remove the latter and permit the realization of a new cycle of filtering of an air flow.

The latter blowing step, which follows the filtering step, permits to avoid having to stop the drying cycles in order to remove the dust from the means for filtering the air flow. The time saving, made possible by the implementation of the method according to the present invention, is therefore significant.

The particles, once they have been blown, then descend along the means used for filtering and reaching a recovery system located in the lower portion of said filtering means, permitting the evacuation of these particles.

After the recirculated air flow has passed a second time through the grain flow, it may again be subjected to a filtering step, which may be followed by a step of blowing the particles.

The air flow, which can be filtered a second time, can then be evacuated to the outside of the dryer 1.

The present invention also relates to a device for implementing the method described above.

In particular, the device for implementing the method according to the invention consists of a grain dryer 1. It includes namely a vertical drying column 3, in which a grain flow passes, thereby permitting to dry, then to cool down the grains. To this end, said vertical column 3 preferably includes a plurality of drying areas and a cooling area for the grains, for example four areas, designated by 31-34 in the attached figure. In particular, the areas 31-33 consist of drying areas and the area 34 of a cooling area. The drying and cooling of the grains is allowed, in the areas 31 to 34 of the column 3, by the passing through of an air flow in a direction substantially perpendicular to the direction of flowing of the grain flow in the vertical column 3.

According to an essential feature, the device according to the invention also includes at least one filtering means for filtering the air flow leaving the vertical column 3 after said air flow has passed through the flow of grains in order to dry the latter, in particular at the level of the lower drying areas 33 and cooling area 34. Said filtering means advantageously permits a retention of the particles and/or dust carried along by the air flow during its passing through the grains.

The device may also include a second filtering means for filtering namely air flow leaving the upper drying areas 31 and 32.

According to a particularly advantageous embodiment of the device ACCORDING TO THE INVENTION, THE FILTERING MEANS CONSISTS OF A FLAT FILTER 4, VISIBLE IN FIG. 1.

Preferably, said flat filter 4 may be contained in a single plane. However, such an embodiment is not restrictive for the invention, and it can also be contemplated that said flat filter 4 includes several facets, for example two facets; in other words, the flat filter 4 can be contained in several planes, for example two planes, so as to increase the filtering surface.

The flat filter 4 can, according to a preferred embodiment, also comprise, for example, a filtering level, which may consist of a filter plate, or a plurality of substantially parallel filtering levels, for example two filtering levels, whereby the latter may either have an identical mesh size or a different mesh size. In this particular case, the mesh size of the first filtering level permits to retain impurities having a determined size and the second filtering level, through which the air flow passes after its passing through the first filtering level, permits to retain impurities having a size smaller than that retained by said first filtering level.

This permits, in a particularly interesting way, to improve the retention capacities of the flat filter 4 the device according to the invention includes.

Interestingly, said flat filter 4 extends parallel to the vertical drying column 3 and over at least part of the height of said column 3.

More preferably yet, the flat filter 4 extends over the part of the drying column 4 corresponding to the lower drying areas 33 and cooling areas 34. Indeed, the air flow transiting in these lower areas 33 and 34 is preferably recycled by passing through the filtering means, namely a flat filter 4, whereby said recycled air flow can then be used in the upper drying areas 31 and 32.

The device may also include a plurality of flat filters, for example 4 and 41, each including at least one filtering level, whereby each filtering level can preferably consist of a filtering plate.

The embodiment in which said device includes two filters 4 and 41 is shown in FIG. 1 and, in this case, the flat filter 41 permits a filtering of the air flow after its passing at the level of the upper portion of the column 3, which corresponds more particularly to the drying areas 31 and 32.

At the exit of the flat filter 4, the air flow is thus free of impurities and can be redirected to the upper drying areas 31 and 32 of the column 3 after having been heated through at least one heating means, e.g. burners 61 and 62.

According to another important feature of the invention, the device also includes at least one movable air-blowing means, the latter being supplied with air by at least one air-supply means.

The movable air-blowing means advantageously permits a blowing of the particles that are trapped in the filter means, whereby the latter may consist of a flat filter 4. The air blown by the air-blowing means is shown in FIG. 1 by the dashed arrows.

In the case in which the flat filter 4 includes several filtering levels, each of these levels is preferably associated with a movable air-blowing means.

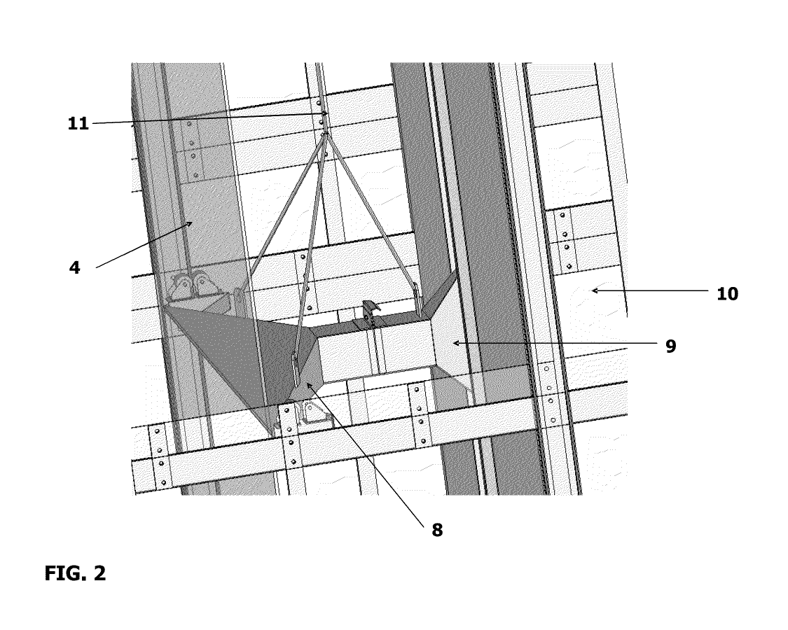

In particular, this movable air-blowing means may consist of a blowing nozzle 8 schematically shown in the attached FIG. 2.

Advantageously, said nozzle 8 has substantially the same width as the filtering means, for example the same width as the flat filter 4, also shown in FIG. 2. In this way, it is possible to eliminate, in a single pass with the blowing nozzle 8, the dust and particles retained over the entire width of the flat filter 4.

Said blowing nozzle 8 is preferably arranged on the side of the filtering means, which is opposite the side where the drying column is located 3. Thus, it is possible to blow air through the filtering means, by means of the blowing nozzle 8, the air being blown substantially parallel to the air flow to be recycled and in an opposite direction. In other words, the air blown by the blowing nozzle 8 passes through the filtering means in the direction opposite the one followed by the air flow passing through this means. This permits a particularly satisfactory removal of the particles and dust trapped in the filtering means, the latter consisting preferably of a flat filter 4.

Of course, in the case in which the dryer 1 includes a plurality of filtering means such as flat filters 4, 41, each of these filters 4, 41 may be associated with a mobile blowing means, such as a blowing nozzle 8, so as to permit an optimal elimination of the particles retained during the passing of the air flow in the filter 4, 41.

In a highly interesting way, the blowing means, namely the blowing nozzle 8, includes means 9 for capturing air, whereby these means 9 may namely include a lip nozzle device.

Turning back now to the means for supplying air to the blowing means, it may in particular consist of a fan 5 and/or a carried-on fan, the latter being not shown in the figures.

More particularly, at the level of the filtering means located at the level of the areas 33 and 34, i.e. the flat filter 4, the air-supply means preferably consists of a fan 5.

Said fan 5 is preferably arranged in the lower portion of the grain dryer 1. It advantageously propels over-pressurized air into a column 10, this propelled air proceeding from an air column 7 of the dryer 1, in which the air is under negative pressure.

Thus, in a very particular embodiment, the air-capturing means 9 of the blowing nozzle 8 permit to take air, which is sent under over-pressure into the column 10 by the fan 5, thereby supplying air to the blowing nozzle 8 for removing the particles trapped in the flat filter 4.

Preferably, a carried-on fan is associated with the blowing means permitting a removal of dust from the flat filter 41 located in the upper portion of the dryer 1, in front of the areas 31 and 32 of the column 3. Such a carried-on fan permits to permanently supply the blowing means with air.

Preferably, said carried-on fan takes air that has been filtered, in order to return it under overpressure at the level said flat filter 41, through a blowing nozzle, so as to permit a removal of the impurities retained by said flat filter 41.

According to an interesting exemplary embodiment, shown in FIG. 2, the device according to the invention also includes means for conveying 11 the mobile blowing means. More particularly, these conveying means 11 namely permit a displacement of said blowing means along the flat filter 4 by pulling from bottom to top and by gravity, or by pulling from top to bottom. Thus, the displacement of the blowing means over the entire height of the flat filter 4 allows a complete cleaning of the latter by removing the particles.

Preferably, the conveying means 11 consist of a winch, not shown in FIG. 2, associated with supporting means represented by cables visible in this figure.

The method and the device according to the invention have many advantages.

The main one of these advantages resides in that all of the air used in the lower portion of the dryer is recycled so as to be re-used in the upper part of this same dryer. In other words, it is not necessary at all, unlike in the traditional methods and devices, to blow external air and to mix it with recycled air. Air proceeding from outside necessarily has a lower temperature than the recycled air that has already circulated through the column 3; therefore, in order to be brought to the adequate temperature for drying the grains, the external air requires a more important energy consumption than recycled air. Therefore, the method and the device according to the invention permit an improvement of the performance of drying of the grains.

In addition, part of the air recycled in the upper portion of the dryer 1, through the flat filter 41, can be re-used in the lower portion of said dryer 1, which also permits an improvement of the performance.

Another advantage of the invention, provided by the use of flat filters 4, 41, associated with the blowing nozzles 8, resides in that the installation of complicated, expensive and bulky suction devices requiring the installation of a piping, a motor and control cabinets is avoided. Instead, the blowing system of the present invention permits an elimination in the lower portion of dust and particles retained in the flat filter 4 and blown through the nozzle 8; the particles may then be evacuated to a waste area.

Furthermore, the blowing system installed does not require interrupting the drying of the grains, since the removal of dust from the filter is carried out continuously, namely by the blowing nozzle.

The invention is not limited to the examples shown and described above, which may have variants and modifications without departing from the scope of the invention.

1. Method for filtering an air flow in a grain dryer to permit recycling, the method comprising the steps of:
entering an external air flow into said grain dryer;
pouring a grain flow by gravity into said grain dryer;
passing said external air flow through the grain flow in a direction substantially perpendicular to a direction of the grain flow;
filtering the air flow after passing through the grain flow, the air flow retaining particles;
heating the filtered flow;
directing the filtered flow upstream of the grain flow, said filtered flow passing again through the grain flow; and
blowing the particles proceeding from the filtered flow.

2. Method for filtering according to claim 1, wherein the air flow is filtered a second time, passing again through the grain flow, the particles resulting from a second filtering being then blown.

3. Device for filtering an air flow through a grain dryer according to claim 1, comprising:
a grain dryer being comprised of a vertical drying column permitting passing through of a flow of grains for drying and cooling grains by circulation of an air flow substantially perpendicular to the direction of the passing through of the grain flow,
at least one filtering means permitting filtering of the air flow leaving said vertical drying column and the retention of particles present in said air flow, and
at least one movable air-blowing means associated with the filtering means, permitting to blow particles proceeding from the filtering, said blowing means being supplied with air by at least one air-supply means.

4. Device for filtering according to claim 3, wherein the filtering means is comprised of at least one flat filter, the flat filter comprising at least one filtering level, and extending over at least part of a height of said vertical drying column of the grain dryer.

5. Device for filtering according to claim 4, wherein said flat filter comprises two filtering levels, each filtering level being comprised of a filtering plate.

6. Device for filtering according to claim 4, wherein said flat filter is contained in a plane.

7. Device for filtering according to claim 4, wherein said flat filter comprises two facets, each facet being contained in two different planes.

8. Device for filtering according to claim 3, wherein the air-supply means comprises at least one of a group consisting of a fan arranged in a lower portion of the grain dryer, and a carried-on fan associated with the blowing means.

9. Device for filtering according to claim 3, wherein the movable air-blowing means comprises a blowing nozzle being arranged on a side of the filtering means opposite a side where the drying column is located, said blowing nozzle having substantially a same width as said filtering means and including at least air-capturing means.

10. Device for filtering according to claim 3, further comprising:
conveying means permitting a displacement of the blowing means along said filtering means.
